(19) United States
(12) Patent Application Publication
(10) Pub. No.: US 2002/0158026 A1
(43) Pub. Date: Oct. 31, 2002

(54) Process for purifying water

(76) Inventor: Douglas Wayne Smith, Miami, FL (US)

Correspondence Address: Trent C. Keisling, HEAD, JOHNSON & KACHIGIAN, E.J. Ball Plaza, Suite 230, 112 West Center Street, Fayetteville, AR, 72701, US

(21) Appl. No.: 09/796,399

(22) Filed: Feb. 28, 2001

(51) Int. Cl. C02F 1/50

(52) U.S. Cl. 210/755; 210/764

(57) ABSTRACT

One or more antibiotics are used as bactericide to eradicate entrained bacteria in treated waste water. Once bacteria have effectively metabolized waste water, they are destroyed using a mixture of antibiotics. These antibiotics are neutralized by an oxidizing agent. Upon oxidation of the antibiotics, the treated effluent is safe for release into the environment. Use of antibiotics for treatment of waste water is safer for the environment. In addition, both antibiotics and quaternary ammonia compounds may be used in a simple method to purify potable water. No neutralization or extraction of the additives is necessary prior to human consumption.

### BACKGROUND OF THE INVENTION

1. Field of the Invention.

The present invention relates to a method for purifying water. In particular, the invention relates to a cheaper, safer and more effective method of disinfecting waste water that has been treated with bacteria so that it may be safely returned to the environment. The invention also relates to a method for purifying potable drinking water.

2. Prior Art

Treatment of waste water is a serious and growing problem in the United States and throughout the world. Waste water released into the environment without proper treatment leads to the pollution of streams and rivers, lakes, oceans and ground water. It also disturbs the delicate balance of our ecosystems. As our scientific knowledge increases, the dangers of polluting our environment become more apparent.

As populations and urban centers grow, so does the amount of sewage water produced. A large variety of organic chemicals must be broken down into safe compounds or removed altogether from sewage before it may be returned to the environment. There are several methods for removing harmful contaminants in sewage prior to release. One method of treating waste water that has gained popularity is the use of bacteria to break down the harmful organic compounds in the raw sewage.

When reacted with certain species of bacteria, the sewage separates into solids and a relatively clean effluent. Given time, the solids will settle into a sludge which may be removed and readily disposed of. The remaining effluent, however, contains a substantial amount of bacteria. The species of bacteria used are themselves usually harmful to the environment, especially when released in large numbers. Because the bacteria used in sewage treatment are dangerous to the environment, the bacteria must also be removed from the effluent before it can be released.

One common method used to remove bacteria from the effluent is to add chlorine. This kills the bacteria, but only replaces one environmental threat with another. Chlorine, even in low concentrations, can be harmful to the environment. Partial dechlorination of the effluent is now required by law. There is therefore a desire to find a less toxic method of treating water that is to be returned to the environment.

Quaternary ammonia compounds (QAC's) are well known in the art as effective antibacterial agents. Their use as bactericide for bacteria laden effluent has been suggested by U.S. Pat. No. 5,976,384. This provides an effective alternative to chlorine. After the quaternary ammonia compound has killed the bacteria, the effluent may be treated with an oxidizing agent. This oxidation neutralizes the bactericide. This allows the effluent to be returned to the environment free of bacteria and bactericide.

It is necessary to neutralize the bactericide. Releasing high concentrations of bactericide into the environment can reduce natural bacterial populations. This disrupts the balance of an ecosystem and can be harmful to the environment. Neutralization of QAC's is cheaper than dechlorinating the effluent and is therefore more practical.

The use of QAC's is an improvement over the use of chlorine as a bactericide. However, incomplete oxidation of QAC's s can lead to undesirable chemicals being introduced into the environment. The volatile nature of these QAC's increases risk of damage to the environment.

Purification of water into potable drinking water, like treatment of waste water, requires the eradication of bacteria present in the water. Fresh water contains a wide variety of microorganisms, many of which can be harmful and even fatal if ingested by humans.

It is therefore desirable to find a means of purifying water to make it suitable for human consumption.

It is also desirable to find a means of treating sewage water in an environmentally safe manner that is also cost efficient.

It is also desirable to find a germicide for treating bacteria laden waste water that is easily neutralized.

### SUMMARY OF THE INVENTION

The present invention hereby incorporates by reference U.S. Pat. No. 5,976,384. The present process is similar in many respects to that used to treat waste water, but a different type of bactericide is used and the present process may be practiced to provide potable water.

The present invention provides for using antibiotics to kill bacteria entrained in waste water effluent. Traditional disinfectants such as chlorine are highly volatile and reactive to most organisms, as are most disinfectants. Antibiotics, however, generally kill microorganisms by disrupting metabolic functions specific only to certain types of living organisms. Thus, an antibiotic may be deadly to one organism and harmless to another. It is this specificity that facilitates their use to counteract infections in humans and to clean wounds on persons or animals. The general public may be unable to distinguish between a disinfectant and an antibiotic. But, those skilled in the art will appreciate the significant difference between the two types of chemicals.

Another significant advantage of antibiotics is that they tend to be more complex. Their modes of function are therefore more complex and subtle than highly reactive antiseptics. Because their method of bacterial destruction is more specific, it is more easily disrupted. Those skilled in the art will recognize that this means antibiotics are more readily neutralized. An antiseptic chemical must generally be fully oxidized before it loses its toxicity. Antibiotics, however, may be completely neutralized by mere partial oxidation. In addition, even complete oxidation of antiseptics can result in by-products that are mildly toxic. Partially oxidized antibiotics, however, are generally completely harmless.

In one exemplary embodiment of the invention, waste water effluent containing bacteria is treated with at least one antibiotic. Because different antibiotics are specific to different classes of microorganisms, a plurality of antibiotics is preferably used to treat the effluent. Many antibiotics are only effective against either gram positive or gram negative microorganisms, not both. It is therefore desirable to use at least two antibiotics, one specific to gram positive bacteria and the other specific to gram negative bacteria. Ideally, there will be some overlap in species specificity between the antibiotics used in order to insure decimation of all bacteria present in the effluent. Combinations of three or more antibiotics may prove even more effective. Which antibiotics, the concentrations and combinations thereof and the time required to effectively kill all bacteria will depend on a variety of factors. These factors will include, but are not limited to, the type of equipment used at a water and/or sewage treatment plant, the types of bacteria present in the water, whether potable or waste, the local climate of a treatment plant's geographic location, the availability and cost of various antibiotics and the personal preferences of the operators of a waste water treatment facility.

Sewage is first placed in a sewage treatment digester where bacteria is introduced. Sewage is broken down into water soluble components and solids. The solids are then removed and the effluent is sent to a mixing station. This station is preferably in the form of a venturi. The venturi design aids in the dissolution and diffusion of antibiotics in the effluent.

After addition of the antibiotics, the effluent is conducted to a reaction zone, such as a holding tank. There the effluent is held for a time sufficient to complete the destruction of entrained bacteria. Further mixing may take place in the reaction zone. Once enough time has elapsed for complete eradication of entrained bacteria, the effluent is conducted to a second mixing station.

The second mixing station is also preferably in the form of a venturi and is used to introduce an oxidizing agent to the effluent. A sufficient amount of oxidizing agent is introduced to completely oxidize the antibiotics in the effluent. Sufficient time is allowed for the oxidation reaction to complete, oxidizing all of the antibiotics present. This is generally a very fast reacton, requiring only a few minutes. A reaction zone, therefore, is generally not necessary, but may be included.

Although antibiotics are generally safe after only partial oxidation, complete oxidation is preferred in order to insure that the effluent is completely safe for return to the environment. Once oxidation is complete, the effluent is safe for release into the environment.

The present invention also provides for use of QAC's as germicidal additives to unpurified water to make it potable. In a relatively short amount of time, QAC's will destroy any bacteria present in the water, including extremely dangerous bacteria such as anthrax. A significant advantage of using QAC's or combinations thereof for the purification of water is that such a small amount is needed. A low concentration of the ammonia compounds required means that the purified water is safe for human consumption directly after treatment. The ammonia compounds do not need to be removed. The presence of QAC's keeps purified water potable for a substantial amount of time after treatment. Another benefit of using QAC's is that the low concentration does not affect the taste of the water.

A mixture of antibiotics may also be effectively used to purify water in order to make it potable. Preferably a mixture of antibiotics is used to insure that all microorganisms present in the water are eradicated. As with purification by QAC's , the antibiotics must be given time to fully react with the bacteria in the water being treated.

It is therefore an object of the present invention to provide effective germicides for the purification of potable water.

It is another an object of the present invention to provide an effective bactericide for the treatment of bacteria laden effluent.

It is another object of the present invention to provide an inexpensive and efficient bactericide for the treatment of bacteria laden effluent.

It is another object of the present invention to provide a bactericide for treatment of bacteria laden effluent that is easily and efficiently neutralized.

### BRIEF DESCRIPTION OF THE DRAWINGS

FIG. 1 shows a flow diagram of the basic components of a system for treating waste water effluent showing the sequence of steps employed in treating the effluent to permit discharge into the environment.

### DETAILED DESCRIPTION OF THE PREFERRED EMBODIMENTS

The present invention provides for using quarternary ammonia compounds for the purification of potable water. Alternatively, antibiotics may by emplyed using the same method resulting in potable water. A high concentration solution of a purification chemical is added to water. A sufficient amount of purification solution is added to achieve a purificationally effective concentration of the purifying agent. The water with added purifying agent is mixed and sufficient time is allowed for the purifying agent to kill substantially all microorganisms in the water being treated. The present invention is effective against a wide variety of bacteria, including anthrax. The amount of time required will depend on a variety of factors. Such factors will be recognized by those skilled in the art of water purification. These factors will include, but are not limited to, the type of equipment used in the purification process, the types of bacteria found in the untreated water, the local climate and the availability and cost of various antibiotics and QAC's . There are a large variety of possible suitable combinations of antibiotics and types of QAC's . Below are some exemplary embodiments of just a few possible purification solutions.

### EXAMPLE 1

In one particular embodiment, the following combination of quaternary ammonia compounds are used:

| Compound | Concentration |
|---|---|
| n-alkyl dimethylbenzyl ammonium chloride | 50 ppm |
| n-alkyl dimethylethylbenzyl ammonium chloride | 50 ppm |

A concentrated solution of equal parts of the above named chemicals is added to water to be purified. A sufficient amount of the concentrated solution is added in order to bring the concentration of the compounds in the water up to those listed above. The total concentration of QAC's is about 100 ppm. The purificationally effective concentration of this particular embodiment ranges from 2 to 200 ppm. Above 200 ppm, the QAC's begin to affect the taste of the water. Therefore, total concentrations above 200 ppm are undesirable. Total concentrations below 2 ppm do not have long residual activity and are therefore less desirable. In addition, lower QAC concentrations take a long time to completely eradicate the bacteria present.

### EXAMPLE 2

In this particular embodiment, the following combination of antibiotics is used:

| Antibiotic | Concentration | |
|---|---|---|
| Bacitracin Zinc | 400 | units/ml |
| Neomycin Sulfate | 3.5 | mg/ml |
| Polymyxin B Sulfate | 5000 | units/ml |

In this example, Polymxcin B is used to kill gram negative bacteria, while bacitracin and neomycin kill both gram positive and gram negative bacteria. Bacitracin is actually a mixture of closely related cyclic polypeptides produced by bacteria.

Antibiotic compounds are premixed to provide a concentrated solution having the antibiotics present in the proper ratios. A sufficient amount of this concentrated solution is added to the water to bring the water to the desired purificationally effective concentrations denoted above. Sufficient time, depending mostly on the concentration of bacteria in the water, is required to completely kill all present bacteria.

### EXAMPLE 3

In another exemplary embodiment, the following concentrations of the following antibiotics may be used:

| Antibiotic | Concentration | |
|---|---|---|
| Neomycin Sulfate | 3.5 | mg/ml |
| Polymyxin B Sulfate | 5000 | units/ml |

As in the first example, the actual length of time required for this mixture to completely eradicate the bacteria present will depend on a variety of factors well known to those skilled in the art of chemistry and sewage treatment.

The present invention also provides for using antibiotics to kill a variety of bacteria, including anthrax, instead of using antiseptics for the treatment of bacteria laden waste water effluent. Antibiotics generally kill microorganisms by disrupting metabolic functions specific only to certain types of living organisms. An antibiotic may be deadly to one organism and harmless to another. It is this specificity that facilitates their use to counteract infections in humans and to clean wounds on persons or animals. Those skilled in the art will appreciate the significant difference between the two types of chemicals.

Antibiotics are more complex than antiseptics, and therefore more fragile. Their modes of function are more complex and subtle than highly reactive antiseptics. Because their method of bacterial destruction is more specific, it is more easily disrupted. Those skilled in the art will recognize that this means antibiotics are more readily neutralized. An antiseptic chemical must generally be fully oxidized before it loses its toxicity. Antibiotics, however, may be completely neutralized by mere partial oxidation. Complete oxidation of antiseptics can still result in by-products that are reactive and volatile. Partially oxidized antibiotics, however, are generally completely harmless.

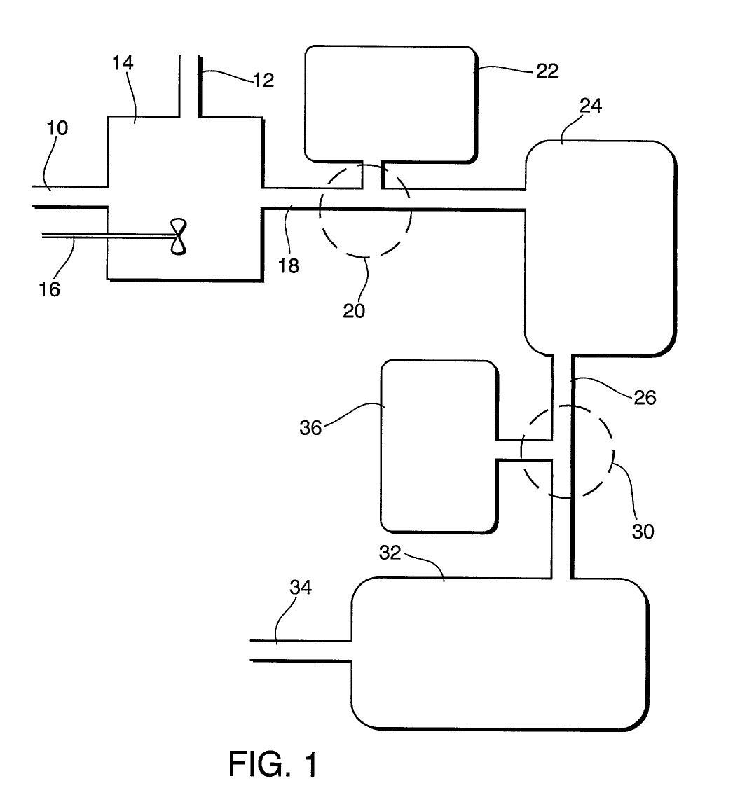

A schematic diagram of a sewage treatment facility 8 utilizing bacteria is shown in FIG. 1. Sewage is first brought to a sewage treatment digester 14 by conduit 10. In digester 14 bacteria is introduced to the sewage by conduit 12. The sewage is mixed by mixer 16 for a time period sufficient to allow complete degradation of organic compounds into water soluble chemicals and solids. The time period required will depend upon a range of factors. After such a time period has elapsed, mixer 16 is stopped and solids are allowed to settle. The solids are then removed and the effluent is sent to a mixing station 20 by conduit 18. This station 20 is preferably in the form of a venturi. An antibiotic composition held in storage tank 22 is injected into the effluent at station 20. The venturi design aids in the dissolution and diffusion of antibiotics in the effluent.

After addition of the antibiotics, the effluent is conducted by conduit 18 to a reaction zone 24, which consists of a holding tank or the like. There the effluent is held for a time sufficient to complete the destruction of entrained bacteria. Further mixing may take place in the reaction zone. Once enough time has elapsed for complete eradication of entrained bacteria, the effluent is conducted by conduit 26 to a second mixing station 30.

The second mixing station 30 is also preferably in the form of a venturi and is used to introduce an oxidizing agent to the effluent. If the oxidatizing agent is a gas such as ozone, then the venturi design may be unnecessary to facilitate thorough mixing. A sufficient amount of oxidizing agent is introduced to completely oxidize the antibiotics in the effluent. Sufficient time is allowed for the oxidation reaction to complete, oxidizing all of the antibiotics present. This is generally a very fast reacton, requiring only a few minutes. A reaction zone 32, therefore, is generally not necessary, but may be included.

Although antibiotics are generally safe after only partial oxidation, complete oxidation is preferred in order to insure that the effluent is completely safe for return to the environment. Once oxidation is complete, the effluent is safe for release into the environment via release conduit 34.

Waste water effluent containing bacteria is treated with at least one antibiotic. Because different antibiotics are specific to different classes of microorganisms, a plurality of antibiotics is preferably used to treat the effluent. Many antibiotics are only effective against either gram positive or gram negative microorganisms, not both. It is therefore desirable to use at least two antibiotics, one specific to gram positive bacteria and the other specific to gram negative bacteria. Ideally, there will be some overlap in species specificity between the antibiotics used in order to insure complete eradication of all bacteria present in the effluent. Combinations of three or more antibiotics may prove even more effective. Which antibiotics, the concentrations and combinations thereof and the time required to effectively kill all bacteria will depend on a variety of factors. These factors will include, but are not limited to, the type of equipment used at a sewage treatment plant, the types of bacteria used to treat waste water, the local climate of a treatment plant's geographic location, the availability and cost of various antibiotics and the personal preferences of the operators of a waste water treatment facility.

The antibiotic or mixture of antibiotics must achieve a puricationally effective concentration within the effluent. A purificationally effective concentration is a concentration that accomplishes substantially complete eradication of all bacteria present in the effluent. If this concentration is not achieved then bacteria may survive the treatment and the effluent will not be safe for release into the environment.

The following examples represent some, but by no means all, possible purificationally affective concentrations of antibiotics that may be used as germicide in waste water treatment.

### EXAMPLE 4

In one particular embodiment, the following combination of antibiotics is used:

| Antibiotic | Concentration | |
|---|---|---|
| Bacitracin Zinc | 400 | units/ml |
| Neomycin Sulfate | 3.5 | mg/ml |
| Polymyxin B Sulfate | 5000 | units/ml |

In this example, Polymxcin B is used to kill gram negative bacteria, while bacitracin and neomycin kill both gram positive and gram negative bacteria. Bacitracin is actually a mixture of closely related cyclic polypeptides produced by bacteria. Being a cyclic polypeptide, it is more fragile and less volatile than antiseptics.

After the reactive bacteria completes its reaction with the waste water, effluent is separated from the sludge. Antibiotic compounds are premixed to provide a concentrated solution having the antibiotics present in the proper ratios. A sufficient amount of this concentrated solution is added to the bacteria laden effluent in a quantity sufficient to bring the effluent to the desired concentrations denoted above. The amount of time required to completely kill the bacteria present will depend on various factors, such as the concentration of the bacteria, the pH of the effluent, ambient temperature and other factors known in the art to influence chemical reaction times.

### EXAMPLE 5

In another exemplary embodiment, the following concentrations of the following antibiotics may be used:

| Antibiotic | Concentration | |
|---|---|---|
| Neomycin Sulfate | 3.5 | mg/ml |
| Polymyxin B Sulfate | 5000 | units/ml |

As in the first example, the actual length of time required for this mixture to eradicate the entrained bacteria will depend on a variety of factors well know to those skilled in the art of chemistry and sewage treatment.

When a mixture of antibiotics is used, the antibiotics may be premixed into a high concentration solution that is added to the effluent. Upon adding a specific amount of antibioitic solution, the effluent attains antibiotic concentrations equal to those listed above.

Both examples 4 and 5 may alternatively utilize separate high concentration antibiotic solutions. Each antibiotic solution may be injected separately into the effluent. Having the antibiotics dissolved into a high concentration solution is preferable to adding antibiotics in a solid form. Predissolution of the antibiotics greatly facilitates dissolution and diffusion of the antibiotics in the effluent. This is further enhanced by use of a venturi.

Whereas, the present invention has been described in relation to the drawings attached hereto, it should be understood that other and further modifications, apart from those shown or suggested herein, may be made within the spirit and scope of this invention.

What is claimed is:

1. A process for purifying water to condition it so that it is suitable for human consumption comprising the steps of:
thoroughly mixing the water with a purificationally effective amount of germicide; and
maintaining the water and germicide mixture for a time sufficient to substantially kill all entrained microorganisms in the water.

2. A process for purifying water according to claim 1 wherein said germicide comprises at least one quaternary ammonia compound.

3. A process for purifying water according to claim 2 wherein said germicide comprises a mixture of equal parts n-alkyl dimethylbenzyl ammonia chloride and n-alkyl dimethylethylbenzyl ammonia chloride.

4. A process for purifying water according to claim 3 wherein the final concentration of said germicide is between 2 and 200 parts per million.

5. A process for purifying water according to claim 4 wherein the final concentration of said germicide is 100 parts per million.

6. A process for purifying water according to claim 1 wherein said germicide comprises at least one antibiotic.

7. A process for purifying water according to claim 6 wherein said antibiotics comprise bacitracin, neomycin and polymyxin B.

8. A process for purifying water according to claim 7 wherein the final concentration of bacitracin is between 50 and 1,000 units per milliliter water, the final concentration of neomycin is between 0 and 10 milligrams per milliliter water, the final concentration of polymyxin B is between 1,000 and 50,000 units per milliliter water.

9. A process for purifying water according to claim 8 wherein the final concentration of bacitracin is 400 units per milliliter water, the final concentration of neomycin is 3.5 milligrams per milliliter water, the final concentration of polymyxin B is 5,000 units per milliliter water.

10. A process for purifying water according to claim 6 wherein said antibiotics comprise neomycin and polymyxin B.

11. A process for purifying water according to claim 10 wherein the final concentration of neomycin is between 0 and 10 milligrams per milliliter water, the final concentration of polymyxin B is between 1,000 and 50,000 units per milliliter water.

12. A process for purifying water according to claim 11 wherein the final concentration of gramicidin is 0.25 milligrams per milliliter water, the final concentration of neomycin is 3.5 milligrams per milliliter water, the final concentration of polymyxin B is between 10,000 units per milliliter water.

13. A process for treating bacteria laden effluent from a sewage treatment digester to condition the effluent for release into the environment comprising the steps of:
(1) thoroughly mixing the effluent with a bactericide comprising at least one antibiotic;
(2) conveying said mixed effluent from step 1 to a reaction zone;
(3) maintaining said mixed effluent in said reaction zone for a time sufficient to substantially kill any entrained bacteria to provide a substantially bacteria free effluent;
(4) mixing an oxidant with said bacteria free effluent;
(5) maintaining the mixture from step 4 for a sufficient time to substantially complete oxidation of the antibiotic in said effluent; and, (6) discharge of the effluent from step (5) into the environment.

14. A process for treating bacteria laden effluent according to claim 13 wherein said bactericide further comprises a plurality of antibiotics.

15. A process for treating bacteria laden effluent according to claim 14 wherein said plurality of antibiotics comprises neomycin and polymyxin B.

16. A process for treating bacteria laden effluent according to claim 15 wherein the final concentration of neomycin is between 0 and 10 milligrams per milliliter effluent, the final concentration of polymyxin B is between 1,000 and 50,000 units per milliliter effluent.

17. A process for treating bacteria laden effluent according to claim 13 wherein the final concentration of neomycin is 3.5 milligrams per milliliter effluent, the final concentration of polymyxin B is between 10,000 units per milliliter effluent.

18. A process for treating bacteria laden effluent according to claim 14 wherein said plurality of antibiotics comprises bacitracin, neomycin and polymyxin B.

19. A process for treating bacteria laden effluent according to claim 18 wherein the final concentration of bacitracin is between 50 and 1,000 units per milliliter effluent, the final concentration of neomycin is between 0 and 10 milligrams per milliliter effluent, the final concentration of polymyxin B is between 1,000 and 50,000 units per milliliter effluent.

20. A process for treating bacteria laden effluent according to claim 19 wherein the final concentration of bacitracin is 400 units per milliliter effluent, the final concentration of neomycin is 3.5 milligrams per milliliter effluent, the final concentration of polymyxin B is 5,000 units per milliliter effluent.
